(19) United States
(12) Patent Application Publication
(10) Pub. No.: US 2004/0117303 A1
(43) Pub. Date: Jun. 17, 2004

(54) Apparatus and anonymous payment system (ASAP) for the internet and other networks

(76) Inventor: Hermogenes Gamboa, Bogota (CO)

Correspondence Address: HERMOGENES GAMBOA, APTO. K1-4, Calle 26 No. 32-20, Bogota, 1, CO

(21) Appl. No.: 10/322,775

(22) Filed: Dec. 16, 2002

(51) Int. Cl. G06F 17/60

(52) U.S. Cl. 705/40; 705/41

(57) ABSTRACT

The apparatus and anonymous payment system is designed to enable users of the Internet and other networks to exchange cash for electronic currency that may be used to conduct commercial transactions world-wide through public networks. This system, known by its initials as ASAP, is a practical way to purchase and sell via the Internet and other networks, without restrictions as to the amount, type of currency, supplier or product. It does not employ traditional media of exchange, banking processes, certifying entities, brokers or financial agents. It offers a high degree of security at low cost, with no prior agreements between users and suppliers.

### BACKGROUND OF THE INVENTION

The advent of electronic resources the world over generated new forms of doing business and conducting transactions in the financial sector. Technological innovations in communications and systematization facilitated the introduction of technology applicable to commerce and banking, just as use of the telephone, teletype, fax, computers, satellites and other inventions facilitated the development of quick and secure media of exchange. Interbank operations, such as drafts and remittances, have become simple and can be conducted at great speed in a reliable way. The public has become accustomed to using electronic teller machines, credit cards and other media of exchange to facilitate business within and between countries. However, with the arrival of the Internet, and other networks and related technology came new ways of doing business and new technological opportunities, as well as new challenges on a global scale.

The appearance of information superhighways and globalization of the economy have revolutionized the world in a way that affects every aspect of life, but particularly trade and finance. These fields obviously embody tremendous challenges and, therefore, additional opportunities for technology. The new questions demand innovative answers. With the boom in use of the Internet, solutions that were appropriate for the former state of technology are not as effective in solving larger and different problems in today's world. New ways of doing business, such as e-business, e-trade, e-commerce and others, for which existing payment systems have proved to be inadequate and unsafe, demand a specialized payment system that offers a specific and secure response. The search for solutions has seen the development of a variety of methods or systems, all of which essentially constitute an effort to adapt old methods or systems to the Internet environment. In other words, traditional media of exchange have tried to become viable for public networks through supposed sophistication in technology and security. As a result, the alternatives proposed to date are costly, of limited application, or difficult to implement in practice.

For these reasons and given the current state of technology, we have invented the Apparatus and Anonymous Payment System, which we call ASAP. It is designed specifically to solve the problems mentioned earlier and to be anonymous, universal, safe, economical, simple and easy to use, all at the same time. Nor does it require prior agreements with suppliers or banks. The ASAP is comprised of the following components: CRYPTOMAC, PINTOKEN and OPERANDUS.

The limitations of previous patents in terms of providing a medium of exchange through the Internet and other networks are obvious when compared with our invention.

Unlike “pseudo-cash” (U.S. Pat. No. 5,913,203 awarded to Wong, et al. on Jun. 15, 1999), the Pintoken in our invention has no handling fee, may be used for purchases of any value, even less than one US dollar, and is so inexpensive to produce it may be distributed free of charge for promotional purposes. Moreover, the value of the acquired Pintoken does not have to coincide with the value of the item to be purchased, as is the case with Internet cash, which is mentioned in the Wong patent. The amount left over from a purchase made with a Pintoken may be used in combination with other Pintokens, or saved with a real or virtual financial entity. Our ASAP system has an advantage over pseudo-cash in that the transaction does not require bank intervention. ASAP has this same advantage over U.S. Pat. Nos. 6,157,920; 5,963,648; 5,590,197; 5,453,601; 6,047,067; 6,023,508; 5,926,548; 5,832,089; 5,799,087; 5,511,121; 5,224,162; 4,977,595; 4,797,920; 5,963,926; 4,752,676; 4,661,658; 6,029,150; 5,889,862 and 5,832,089, as it operates its own Pintoken sale and verification system. This system may be used by the public network, because ASAP authorizes or denies the transaction independently. The security in an ASAP transaction depends on the process used, not on the number of characters, as with pseudo-cash, which depends on the PIN and the PISN. Moreover, association with a bank is not required, nor is a customer account or buyers credit, and there is no involvement through private information with the system administrator or with suppliers.

As opposed to “smart token” technology (U.S. Pat. No. 5,943,423 granted to Sead Muftic on Aug. 24, 1999), our invention requires no programming interface with the computer, or elements to interact with its peripherals. Nor does it require public or private character codes or a digital signature from a certifying entity. For this reason, the Pintoken is more universal and more economical. Our invention; that is, ASAP, has its own character codes, making it simpler and more secure. Inasmuch as it does not involve banks, ASAP requires no authorization or prior agreement with consumers or suppliers. The Pintoken in ASAP is different from the token cited in the aforementioned patent, as it does not require a chip, magnetic band or special hardware in the users computer. For this reason, a smart token or smart drive is not needed. Being sophisticated mechanisms, these only add to the cost of implementation.

Contrary to “electronic cash” (U.S. Pat. No. 5,983,207 granted to James J. Turk in November 1999), the Pintoken in our invention need not be backed by gold or any other metal, since it is based on the local currency in each country and, therefore, is not subject to risk of inflation or changes in currency value. As to information on account status, the invention implies no cost for storage or transactions with third parties, because it has no account statements that depend on others and does not require user identification. This makes it more economical, more secure and more private.

Some of the patents granted to date; namely U.S. Pat. Nos. 6,157,920; 6,092,202; 5,907,832; 5,265,162; 5,926,548; 5,799,087; 5,224,162; 4,797,920; 5,590,197; 5,924,084; 5,963,926; 5,311,594; 4,752,676, 4,661,658; 5,924,084; 5,832,089 and 5,889,862, base their security on the smart card. This is not, however, the case of the present invention, where security is based on the combination of a private system, the users PIN, private encryptation and its own software isolated from public networks. Moreover, for communication and verification, the aforementioned patents use existing smart card technology. This makes his invention more costly and vulnerable compared with the present invention, which uses a private system with simple technology specific for this application.

Unlike “smart card” technology (U.S. Pat. No. 5,613,001 awarded to Bakhoum on Mar. 18, 1997), the ASAP of the present invention relies on an encrypted code associated with a phrase, which changes over time to achieve a particular encryptation in each Cryptomac and each Pintoken. Furthermore, the algorithms used by Bakhoum are not employed, as they are not needed to ensure security of the process via the Internet. ASAP does not use smart cards with logical circuits; it uses Pintokens instead, which require none of the sophistication mentioned earlier.

In contrast to the smart card (U.S. Pat. No. 5,566,327 awarded to James J. Turk on Nov. 9, 1999), the Pintoken, aside from not being a smart card, requires no predefined percentile allocation to purchase various products or services. The Pintoken user is free to select the products he wants to purchase by contacting our URL address.

### FIELD OF THE INVENTION

The present invention relates to the implementation of an anonymous and secure payment system for transactions conducted via electronic media, such as the Internet, with transaction verification through encryptation, authentication, double spending detection, code management, and PIN verification. Accordingly, the current US classes are:

DATA PROCESSING: FINANCIAL, BUSINESS PRACTICE, MANAGEMENT, OR COST/PRICE DETERMINATION

BUSINESS PROCESSING USING CRYPTOGRAPHY

Secure transaction

Including authentication

Electronic cash detail (e.g., detecting double spending)

Electronic cash Including key management

Verifying PIN

Anonymous user system

Transaction verification

### BRIEF DESCRIPTION OF THE FIGURES

FIG. 1 is a schematic of the anonymous payment system

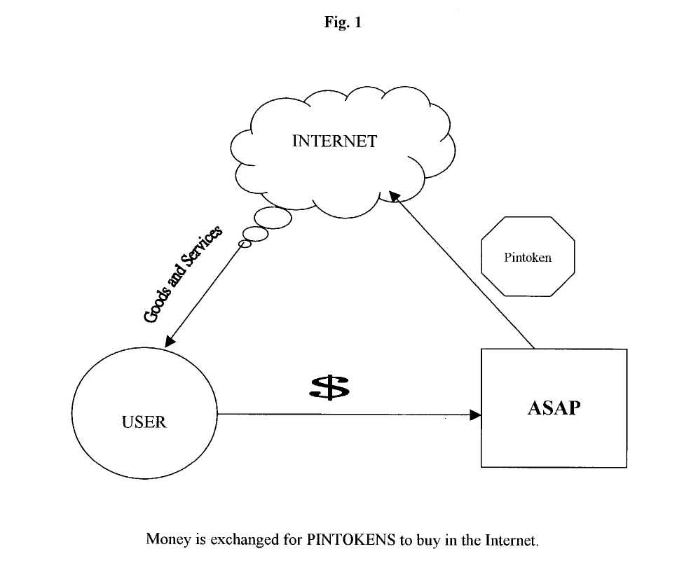

FIG. 2 is a schematic of ASAP

FIG. 3 is the logo of the anonymous payment system

FIG. 4 is an exemplary embodiment of the pintoken

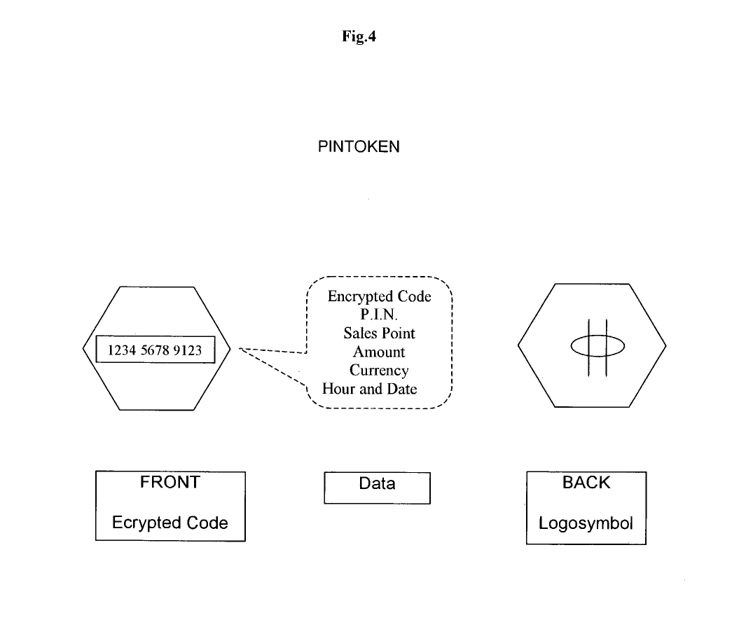

### SUMMARY OF THE INVENTION

ASAP serves as a universal medium of exchange for the Internet. Within the public network and with the PINTOKEN, it is possible to safely purchase practically any item anywhere in the world, for any amount and with any type of currency. The media of exchange currently in existence are limited, since they are based on prior agreements with suppliers or banks, and users must obtain prior authorization from financial systems. ASAP has none of these limitations. Its users need not have a bank account, as information on their credit rating is not a requirement for using the Pintoken. With ASAP, currency does not depend on backing in gold or any other metal, but on the official exchange rate and the system as such. Nor does its operation depend on certifying entities or financial agents or brokers.

ASAP is less costly than other media of exchange currently used in electronic systems (including the Internet), such as cards (credit, debit, smart and virtual), checks, bank notes and the like. Due to its simplicity, the Pintoken is less expensive to produce than traditional elements used to perform similar functions. This is because it is smaller and requires no special materials, such as chips, electronic circuits or magnetic bands. The system administration process is more economical, as it implies no fees for storage or transaction, as it is not required to provide information on account balances. This implies less sophisticated equipment and, therefore, less capital for implementation.

ASAP is completely safe because the user employs only one PIN, which he selects privately. ASAP combines this PIN with ciphered information, which is incorporated into the Pintoken during its manufacture and is unknown to the user. At no time does ASAP use banking networks, cards or electronic teller machine (ATM) networks, which make other existing systems vulnerable. The transaction is doubly protected by hardware and by software.

The Pintoken is either a real object or a virtual one, which can be used by selecting the icon existing on web pages, in cellular telephones, or by using wireless access protocols, such as WAP and the like. It is anonymous, inasmuch as the buyer need not identify himself or provide confidential or financial information to acquire or use the Pintoken. It is equivalent to a prepaid card, but does not rely on a bank account and has no handling fee, as its value is equal to the value paid at the time of purchase.

### DETAILED DESCRIPTION OF THE INVENTION, AND PREFERRED EMBODIMENTS THEREOF

The invention, known as ASAP, is an anonymous payment system for the Internet and other communication networks. It is comprised of an electromechanical apparatus called a CRYPTOMAC, a real or virtual token called a PINTOKEN, and a system called OPERANDUS.

The CRYPTOMAC is an integrated set of electromechanical devices that operate together to receive money in cash and to dispense electronic money or the equivalent value in the form of an element valid for purchase or sale on the Internet. This electronic element is called a “Pintoken”. The Cryptomac may take various external forms and may be powered by continuous or alternating current. However, in all cases, it has the capacity to produce, acknowledge, interpret, store and transmit digital and analog data for multiple functions: i.e., to acknowledge, receive and store money in cash, to encrypt and store data, to collect information, to mix and package data, to print and to transmit via a communication network.

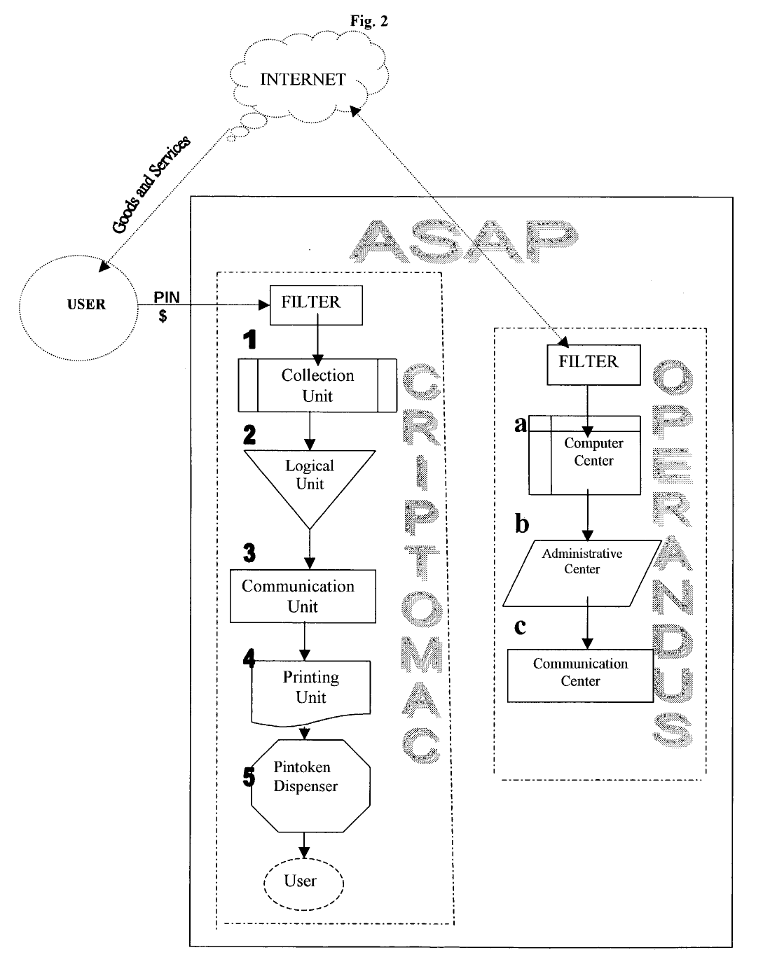

To explain how the Cryptomac operates, we divide it into the following units: (1) Collection, (2) Logic, (3) Communications, (4) Printing and (5) Supply (FIG. 2).

In unit (1), instructions for use are transferred to a digital monitor, money is received in cash from the user by means of a device similar to that of a vending machine, and the user identification number (PIN) is collected via an alphanumeric keyboard. These operations are sent as digital information (amount, value and PIN) to unit (2), which is essentially an electronic processor where this digital information is processed and encrypted in association with the date, time and previously-stored secret codes, to produce the Pintoken number (#). This number, in its digital form, is sent simultaneously to a database in the same unit and to units (3) and (4). Unit (3) is basically a smart digital telephone unit capable of communication with a public or private network. In unit (4),a digital printer prints the number (#) on a blank Pintoken stored in a dispenser feeder, then delivers it to unit (5), where the process is verified. Once it has been validated, the finished Pintoken is delivered to the user.

The PINTOKEN is an element we have invented as a real or virtual medium of exchange for business transactions in real or virtual media. Like currency, it may be used to express the value of goods and services.

The REAL PINTOKEN has the following features:

1. It is a physical object able to contain printed information. It may be symmetrical in form (we will use the hexagon to facilitate visualization, but it may be produced in rectangular, circular or any other geometric form) and may be made of metal, plastic, cardboard or similar materials.

2. Printed on one side of each Pintoken is a number (#) identifying it as unique. The other side contains ciphered information, in addition to a “logosymbol”. The Pintoken may have printed codes or advertising.

The VIRTUAL PINTOKEN has the following features:

1. It is an icon in the form of a real Pintoken and can appear on a computer monitor and other electronic apparatus, in association with a program that simulates all the functions of a real Pintoken.

2. It may be purchased and sold on line and is used in the same way as a real Pintoken. It may also be used as a promotional medium and, in special cases, to handle large accounts.

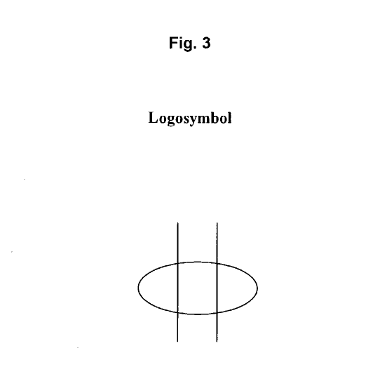

The LOGOSYMBOL is an oval overlaid with two parallel lines similar to those used in the dollar and peso signs, as illustrated in FIG. 3.

How to Use the Pintoken

To know the value of the Pintoken required for a purchase, it is suggested the user first obtain information on the product or service in question and its value in local currency, based on the representative exchange rate for currencies accepted in international commerce. Said information should be obtained through the selected electronic medium (e.g. the Internet). With this information in hand, the user may acquire a Pintoken at any sales point that is equipped with a cyptomac and use it to purchase via the Internet or a similar medium. Pintoken are sold with a fixed value in local currency. The ASAP system calculates the equivalent value in the currency to be used, based on the official exchange rate valid for the day in question.

The following is the procedure for purchasing on the Internet:

1. The user acquires a Pintoken from the CRYTOMAC, in the value needed to cover the cost of the transaction. This is done in three easy steps: place the money in the machine, type the PIN on the keyboard, then remove the Pintoken from the dispenser.

2. The user enters the URL address of ASAP on his computer and, from there, establishes a link with the Internet page where he selects and accepts the value of the product or service to be purchased. After entering the Pintoken number (#), the user sees the details of the transaction and the proposed invoice on his monitor, together with the acceptance button and the PIN entry request. If the user accepts, the administrative center deducts this amount from the Pintoken, finalizing the purchase.

When employing a medium of communication other than the Internet, the process is similar but uses the protocols of each network.

Internal Process

The Pintoken and the Cryptomac integrate with the Operandus programs to facilitate transactions, which are conducted through electronic media.

The internal procedures is as follows:

1. The cryptomacs are factory produced and assigned unique codes. Simultaneously, the Operandus, with the programmed computing center, deciphers the cryptomac codes.

2. The blank Pintokens are factory produced. One side may be blank. The other may be printed with the logosymbol and the value and type of currency. In some cases, advertising or other information may be printed on the Pintoken.

3. The “blank” forms are placed in the cryptomacs.

4. When the Pintoken is sold, the user selects his PIN on the CRYPTOMAC keyboard. This PIN is encrypted on the basis of codes decided previously with Operandus. The result is the number (#) is printed on the blank side of the Pintoken.

5. The numbered Pintoken is then delivered to the user via the dispenser.

6. When the user accesses the URL address of ASAP and types the number (#) of the Pintoken, the Operandus confirms its validity and deciphers the associated PIN, together with the amount of the balance. Once the total value of the transaction is known, the administrative center asks the user to type in his PIN. If it coincides with the deciphered PIN and the balance is sufficient, the purchase is authorized. If not, it is denied.

7. After the purchase is made, there may be money left on the Pintoken. Said balance may be used by itself (prior to the expiration date) or in combination with balances on other Pintokens, which may be purchased to acquire the funds necessary to conduct a transaction of a higher value.

8. The Operandus is in charge of forwarding the money to suppliers, when they agree to provide goods and services.

What is claimed is:

1. An anonymous payment system, known as ASAP, which allows users of the Internet and other networks to acquire goods and services on line, without the need for a bank account, credit or debit card, or prior agreements with suppliers; the system in question is comprised of:
an electromechanical apparatus known as a CRYPTOMAC, wherein money in local currency is received in exchange for electronic currency;
a real or virtual representation of the value of the currency, known as a PINTOKEN;
a set of systems, programs and methods allowing for secure transactions on a communications network known as OPERANDUS.

2. The electromechanical apparatus (Cryptomac) of claim 1, wherein the Pintokens of claim 1 are produced independently, the Cryptomac is comprised of:
a filter, wherein undesired access to information is avoided and unauthorized observation of existing information is prevented;
a collection unit, with a keyboard for entering a personal identification number or PIN, wherein money is received in cash;
a logical unit, wherein encrypted alphanumeric codes to be mixed with the PIN are generated, stored and processed electronically and wherein an encrypted code known as the Pintoken Number (#) is produced;
a communication unit, wherein the logical unit is communicated with public or private networks;
a printing unit, wherein the Pintoken number (#) is printed securely; a supply unit, wherein existence of the currency in the collection unit is confirmed and said datum is compared with information from the logical unit and the communication unit, prior to dispensing the Pintokens.

3. The currency representation (Pintoken) of claim 1, in real or virtual form, the visible form of which contains:
a number (#) that makes the Pintoken unique, due to an encrypted code that includes the user's PIN;
the value and type of currency;
the logosymbol
printed and/or advertising information.

4. The set of program systems and methods (OPERANDUS) of claim 1, which contains:
a filter, wherein independence between the Internet and other public or private networks and the components of the Operandus of claim 1 is guaranteed;
a computing center, wherein previously ciphered information is contained and processed, and is compared with information from the Internet for the purpose of validation;
an administrative center, which serves as an intermediary between the Internet and the computing center and wherein information from the network and from the user is handled securely;
a communication center, wherein information on the public network is managed via a web page or web site.

5. The system (ASAP) of claim 1, useful as a universal medium of exchange on the Internet, by any user of the network, with any currency and in any part of the world.

6. The system (ASAP) of claim 1, wherein operation does not rely on certifying entities, financial agents or brokers, bank networks, cards, or electronic teller machines known as ATMs.

7. The system (ASAP) of claim 1, wherein the equivalent amount of the currency is calculated and the user is allowed to conduct transactions in currencies other than the currency of his country of origin.

8. The system (ASAP) of claim 1, as a medium of exchange requiring no-prior agreement with suppliers or banks.

9. The system (ASAP) of claim 1, wherein no affiliation with a bank is required of users, nor is their credit rating consulted.

10. The system (ASAP) of claim 1, wherein users employ a single PIN selected privately, by them, when using the Cryptomac of claims 1 and 2, which combines said PIN with ciphered information particular to the Cryptomac and unknown to the user, to produce the number (#) of the Pintoken of claims 1 and 3.

11. The filter of claim 2, kept secret for security purposes.

12. The collection unit of claim 2, wherein cash and credit or debit cards are received and a personal identification number (PIN) is entered into the logical unit of claim 2, by means of a keyboard.

13. The logical unit of claim 2, wherein the encrypted code or Pintoken number (#) of claim 2 is produced independently and autonomously, based on the PIN established by the user and the codes agreed previously with the Operandus of claim 4, which are different for each of the cyptomacs of claim 2.

14. The communication unit of claim 2, wherein information is stored and transmitted through public or private networks.

15. The printing unit of claim 2, wherein the number (#) obtained via the process of claim 13 is recognized and printed securely on the surface of the Pintoken of claim 3.

16. The supply unit of claim 2, wherein the Pintokens of claim 3 are dispensed with all the components of claim 3, including the number (#) of claims 2 and 3.

17. The currency representation (Pintoken) of claim 1, which may be real or virtual, and may be used by selecting the icon on web pages, in cellular telephones or by using wireless access protocols such as WAP or the like.

18. The Pintoken number (#) of claims 2 and 3, which is visible to the user, although it contains secret information and codes that can be deciphered only by the Operandus of claim 4.

19. The Pintoken number (#) of claims 2 and 3, which can be transmitted openly, via a public network, without risk, inasmuch as, in itself, it is of no value to persons or entities other than the user of the administrative center of claim 4.

20. The Pintoken number (#) of claims 2 and 3, which contains the user's PIN in ciphered form recognizable only to the computing center of claim 4.

21. The value and type of currency of claim 3, identifiable visually by the user and electronically by the Operandus of claim 4.

22. The logosymbol of claim 3, consisting of an oval overlaid with two vertical lines, as illustrated in FIG. 3.

23. The printed and/or advertising information of claim 3, to inform users and/or to finance the medium of exchange of claim 1.

24. With the Pintoken of claims 1, 3 and 17, Internet users may safely purchase any goods or services on the public network, from any URL address, for any value and with any type of currency.

25. The set of systems, programs and methods (Operandus) of claim 1, able to communicate with public networks, to interpret the Pintoken number (#) of claim 3 and to allow access and to validate information from the Internet securely.

26. The filter of claim 4, wherein independence between the Internet and other public or private networks and the computing center and the administrative center is ensured.

27. The computing center of claim 4, wherein ciphered information is contained and processed, then validated with the information from the administrative center of claim 4, with the help of distinctive hardware and software.

28. The administrative center of claim 4, wherein the computing center of claims 4 and 27 and the communication center of claim 4 are kept separate and data from the network and the user are handled securely.

29. The communication center of claim 4, wherein on-line communications with users and their suppliers are managed through Internet resources.

30. The communication center of claim 4 includes a predetermined URL address allowing the user to link with an Internet page where he selects and accepts the value of the product or service to be acquired. The details of the transaction and an invoice are posed to the user from this. URL address, together with an acceptance button. If the user accepts, the administrative center of claims 4 and 28 deducts said value from the Pintoken, finalizing the purchase.

31. The communication center of claim 4, with a URL address accessed by the user with the Pintoken number (#), which the computing center program confirms by consulting its database, with simultaneous consultation on the available balance. If there is a balance available, the administrative center asks the user for his PIN and asks the computing center to validate it. If the PIN coincides with the number deciphered by the computing center, the transaction is authorized. If not, it is denied.

32. The Operandus of claim 1 acts as an intermediary between users and suppliers, delivering to the supplier payment for purchases.

33. The system (ASAP) of claim 1, as an anonymous medium of exchange, is available to any user, without the need to supply confidential or financial information.

34. The Pintoken of claim 1, as low-cost electronic currency, requires no electronic circuits, special materials or magnetic bands or chips, nor are there costs for storage or transactions, as it does not require a supply of information on account balances, nor are there handling fees for users.

35. The Pintoken of claim 1, wherein excess or surplus currency from a purchase is managed and may be used by itself or added to the value of other Pintokens.

36. The Pintoken of claim 1 may take any geometric form and may be made of materials such as metal, cardboard or plastic; wherein like a coin it has monetary value and it may be used as a promotional medium.

37. The Cyptomac and Operandus of claim 1, guarantee security because they are totally independent and are not connected to any network.

38. The ASAP, Cyptomac, Pintoken and Operandus of claim 1 may be used to facilitate and conduct business via electronic media, such as purchases over the Internet, electronic transfers of currency and securities, on-line payment of invoices and public utilities, etc.

39. The ASAP system of claim 1 wherein the system is capable of receiving currencies of different nationalities.
